(19) United States
(12) Patent Application Publication
(10) Pub. No.: US 2015/0242523 A1
(43) Pub. Date: Aug. 27, 2015

(54) METHODS, SYSTEMS AND PROGRAMS FOR RETRIEVING INFORMATION ON THE INTERNET

(71) Applicant: YANDEX EUROPE AG, Luzern (CH)

(72) Inventors: Konstantin Pavlovitch Gorskiy, Moscow (RU); Nikolay Anatolievitch Yaremko, Ekaterinburg (RU); Alexander Sergeevitch Bykov, Moscow (RU)

(21) Appl. No.: 14/433,029

(22) PCT Filed: Oct. 1, 2013
(86) PCT No.: PCT/US2013/062791

§ 371 Date: Apr. 1, 2015

(30) Foreign Application Priority Data
Oct. 1, 2012 (RU) PCT/RU2012/000801
Apr. 1, 2013 (RU) 2013115564

(51) Int. Cl. G06F 17/30

(52) U.S. Cl. CPC G06F 17/30882; G06F 17/30864; G06F 17/3053

(57) ABSTRACT

Information retrieved from the Internet, including search results and an Internet resource, are displayed within a web browser on a client device, in visual proximity. The search results are provided to the client device by at least one server in respect of a search query. The displayed Internet resource may relate to a user selection of a search result on the web browser. Alternatively, the displayed Internet resource may comprise a highest ranked result of the search query, the Internet resource being displayed in visual proximity of the search results before an actual user selection of a result of the search. The at least one server may provide instructions to the client device for displaying the search results and the Internet result in visual proximity.

### CROSS-REFERENCE

The present application claims convention priority to (1) International Application No. PCT/RU2012/000801, filed Oct. 1, 2012, entitled “Methods, Systems And Programs For Retrieving Information On The Internet” and to (2) Russian Patent Application No. 2013115564, filed Apr. 1, 2013, entitled “Methods, Systems And Programs For Retrieving Information On The Internet”. These applications are incorporated by reference herein in their entirety. The following applications are also incorporated by reference herein in their entirety: (1) International Application No. PCT/RU2012/000799, filed Oct. 1, 2012, entitled “Method and Browser for Displaying Overlaid Webpages”; (2) International Application No. PCT/RU2012/000800, filed Oct. 1, 2012, entitled “Method and System for Navigating to a Sub-Resource of an Internet Resource”; (3) International Patent Application No. PCT/RU2012/000798, filed Oct. 1, 2012, entitled “Method of and System for Providing Information to a User of a Client Device”; (4) Russian Patent Application No. 2013115565, filed Apr. 1, 2013, entitled “Method and Browser for Displaying Overlaid Webpages”; (5) Russian Patent Application No. 2013115566, filed Apr. 1, 2013, entitled “Method and System for Navigating to a Sub-Resource of an Internet Resource”; and (6) Russian Patent Application No. 2013115567, filed Apr. 1, 2013, entitled “Method of and System for Providing Information to a User of a Client Device”.

### FIELD

The present specification relates to the field of Internet searches. More specifically, the present disclosure relates to methods, systems and programs for retrieving information on the Internet.

### BACKGROUND

One of the most popular applications in the field of server-client systems relates to search engines. A user may use a browser, for example Internet Explorer™, Mozilla Firefox™ or Google Chrome™ to access a search engine server, for example Yandex™, Google™, Bing™. The user submits one or more key words in a request to obtain a list of web pages that contain the key words. The search engine server provides a list of references to relevant web sites. Each reference of the list is presented on a browser window with a selectable link and, usually, with additional information such as, for example, a few words or an image from a web site that contains the key words. This information may be useful in aiding the user in selecting an appropriate one of the many references provided by the search engine server.

When the user selects a given provided reference, the search engine server or another server transfers a selected web page content that replaces, on the browser window, the list of references provided by the search engine. The user may find that the selected web page content provides the desired information and that the key word based request has been fulfilled. Oftentimes, the user will realize that the desired information is not found, or only partially found, in the selected web page. The user may use a so-called “back” icon on the browser to return to the list of references; this action causes the browser window to stop displaying the previously selected web page. The user may select a new reference or return to the same reference, either by selecting again the same reference or using a so-called “forward” icon on the browser. Comparison of various web page contents imposes on the user to memorize, at least temporarily, information of the list of references and information from the selected reference.

Further improvements to conventional methods and nodes for displaying information to the benefit of users are therefore desirable.

### SUMMARY

It is an object of the technology disclosed in the present specification to ameliorate at least some of the inconveniences present in earlier solutions.

According to a first aspect, the technology disclosed in the present specification provides a method of retrieving information from the Internet, comprising:

sending, by a client device to at least one server, a search query to be searched;

receiving, by the client device from the at least one server, search results in respect of the search query;

displaying the search results on the client device within a web browser on a search engine results page, the search results including at least an ordered series of hyperlinks pointing to Internet resources;

receiving, by the client device, a selection from a user of the client device of one of the ordered series of hyperlinks;

sending, by the client device to the at least one server, instructions for furnishing the client device with the Internet resource to which the selected one of the ordered series of hyperlinks points;

receiving, by the client device from the at least one server, the selected Internet resource;

reorganizing the display of the search engine results page within the web browser on the client device; and displaying the selected Internet resource on the client device within the web browser in visual proximity to the reorganized search engine results page, while continuing to display the reorganized search engine results page.

According to a second aspect, the technology disclosed in the present specification provides a method of retrieving information from the Internet, comprising:

sending, by a client device to at least one server, a search query to be searched;

receiving, by the client device from the at least one server, search results in respect of the search query;

displaying the search results on the client device within a web browser on a search engine results page, the search results including at least an ordered series of hyperlinks pointing to Internet resources; and

displaying the Internet resource to which a first one of the ordered series of hyperlinks points on the client device within the web browser in visual proximity to the search engine results page, while continuing to display the search engine results page, without the client device having received a selection from a user of the client device of the first one of the ordered series of hyperlinks.

According to a third aspect, the technology disclosed in the present specification provides a method of supplying information retrieved from the Internet to a client device, comprising:

receiving, by at least one server from the client device, a search query to be searched;

effecting, by the at least one server, a search in respect of the search query;

sending, by the at least one server to the client device, search results in respect of the search query, and instructions to the client device to display the search results on a search engine results page within a web browser on the client device, the search results including at least an ordered series of hyperlinks pointing to Internet resources;

receiving, by the at least one server from the client device, instructions for furnishing the client device with an Internet resource to which a user-selected one of the ordered series of hyperlinks points; and

sending, by the at least one server to the client device, instructions to reorganize the display of the search engine results page within the web browser on the client device, the user-selected Internet resource, and instructions to display the user-selected Internet resource on the client device within the web browser in visual proximity to the reorganized search engine results page while continuing to display the reorganized search engine results page.

According to a fourth aspect, the technology disclosed in the present specification provides a method of supplying information retrieved from the Internet to a client device, comprising:

receiving, by at least one server from the client device, a search query to be searched;

effecting, by the at least one server, a search in respect of the search query;

sending, by the at least one server to the client device, search results in respect of the search query, and instructions to the client device to display the search results on a search engine results page within a web browser on the client device, the search results including at least an ordered series of hyperlinks pointing to Internet resources; and

sending, by the at least one server to the client device, an Internet resource to which a first one of the ordered series of hyperlinks points and instructions to display the Internet resource within the web browser in visual proximity to the search engine results page, while continuing to display the search engine results page, without the at least one server having received user-initiated instructions to furnish the Internet resource.

According to a fifth aspect, the technology disclosed in the present specification provides a system for retrieving information from the Internet, comprising a client device, the client device including:

a computer processor;

a display device operationally connected with the computer processor;

a user interface operationally connected with the computer processor;

a communication interface operationally connected with the computer processor and structured and configured to communicate with at least one server; and

a non-transient computer information storage device operationally connected with the computer processor, the information storage device containing program instructions that, when executed by the computer processor effect:
a sending, by the client device to the at least one server, of a search query to be searched;
a receiving, by the client device from the at least one server, of search results in respect of the search query;
a display of the search results on the client device within a web browser on a search engine results page, the search results including at least an ordered series of hyperlinks pointing to Internet resources;
a receiving, by the client device, of a selection from a user of the client device of one of the ordered series of hyperlinks;
a sending, by the client device to the at least one server, of instructions for furnishing the client device with the Internet resource to which the selected one of the ordered series of hyperlinks points;
a receiving, by the client device from the at least one server, of the selected Internet resource;
a reorganization of the display of the search engine results page within the web browser on the client device; and
a display of the selected Internet resource on the client device within the web browser in visual proximity to the reorganized search engine results page, while continuing to display the reorganized search engine results page.

According to a sixth aspect, the technology disclosed in the present specification provides a system for retrieving information from the Internet, comprising a client device, the client device including:

a computer processor;

a display device operationally connected with the computer processor;

a user interface operationally connected with the computer processor;

a communication interface operationally connected with the computer processor and structured and configured to communicate with at least one server; and

a non-transient computer information storage device operationally connected with the computer processor, the information storage device containing program instructions that, when executed by the computer processor effect:
a sending, by the client device to the at least one server, of a search query to be searched;
a receiving, by the client device from the at least one server, of search results in respect of the search query;
a display of the search results on the client device within a web browser on a search engine results page, the search results including at least an ordered series of hyperlinks pointing to Internet resources; and
a display of the Internet resource to which a first one of the ordered series of hyperlinks points on the client device within the web browser in visual proximity to the search engine results page, while continuing to display the search engine results page, without the client device having received a selection from a user of the client device of the first one of the ordered series of hyperlinks.

According to a seventh aspect, the technology disclosed in the present specification provides a system for supplying information retrieved from the Internet to a client device, comprising at least one server, the at least one server including:

a computer processor;

a database operationally connected with the computer processor, the database containing the information retrieved from the Internet;

a communication interface operationally connected with the computer processor and structured and configured to communicate with the client device; and

a non-transient computer information storage device operationally connected with the computer processor, the information storage device containing program instructions that, when executed by the computer processor effect:
a receiving, by at the least one server from the client device, of a search query to be searched;
an effecting, by the at least one server, of a search in respect of the search query;
a sending, by the at least one server to the client device, of search results in respect of the search query, and of instructions to the client device to display the search results on a search engine results page within a web browser on the client device, the search results including at least an ordered series of hyperlinks pointing to Internet resources;
a receiving, by the at least one server from the client device, of instructions for furnishing the client device with an Internet resource to which a user-selected one of the ordered series of hyperlinks points; and
a sending, by the at least one server to the client device, of instructions to reorganize the display of the search engine results page within the web browser on the client device, of the user-selected Internet resource, and of instructions to display the user-selected Internet resource on the client device within the web browser in visual proximity to the reorganized search engine results page while continuing to display the reorganized search engine results page.

According to an eighth aspect, the technology disclosed in the present specification provides a system for supplying information retrieved from the Internet to a client device, comprising at least one server, the at least one server including:

a computer processor;

a database operationally connected with the computer processor, the database containing the information retrieved from the Internet;

a communication interface operationally connected with the computer processor and structured and configured to communicate with the client device; and

a non-transient computer information storage device operationally connected with the computer processor, the information storage device containing program instructions that, when executed by the computer processor effect:
a receiving, by at the least one server from the client device, of a search query to be searched;
an effecting, by the at least one server, of a search in respect of the search query;
a sending, by the at least one server to the client device, of search results in respect of the search query, and of instructions to the client device to display the search results on a search engine results page within a web browser on the client device, the search results including at least an ordered series of hyperlinks pointing to Internet resources; and
a sending, by the at least one server to the client device, of an Internet resource to which a first one of the ordered series of hyperlinks points, and of instructions to display the Internet resource within the web browser in visual proximity to the search engine results page, while continuing to display the search engine results page, without the at least one server having received user-initiated instructions to furnish the Internet resource.

According to a ninth aspect, the technology disclosed in the present specification provides a non-transient computer information storage medium containing program instructions that when executed by a computer processor of a client device effect:

a sending, by the client device to at least one server, of a search query to be searched;

a receiving, by the client device from the at least one server, of search results in respect of the search query;

a display of the search results on the client device within a web browser on a search engine results page, the search results including at least an ordered series of hyperlinks pointing to Internet resources;

a receiving, by the client device, of a selection from a user of the client device of one of the ordered series of hyperlinks;

a sending, by the client device to the at least one server, of instructions for furnishing the client device with the Internet resource to which the selected one of the ordered series of hyperlinks points;

a receiving, by the client device from the at least one server, of the selected Internet resource;

a reorganization of the display of the search engine results page within the web browser on the client device; and

a display of the selected Internet resource on the client device within the web browser in visual proximity to the reorganized search engine results page, while continuing to display the reorganized search engine results page.

According to a tenth aspect, the technology disclosed in the present specification provides a non-transient computer information storage medium containing program instructions that when executed by a computer processor of a client device effect:

a sending, by the client device to the at least one server, of a search query to be searched;

a receiving, by the client device from the at least one server, of search results in respect of the search query;

a display of the search results on the client device within a web browser on a search engine results page, the search results including at least an ordered series of hyperlinks pointing to Internet resources; and

a display of the Internet resource to which a first one of the ordered series of hyperlinks points on the client device within the web browser in visual proximity to the search engine results page, while continuing to display the search engine results page, without the client device having received a selection from a user of the client device of the first one of the ordered series of hyperlinks.

According to an eleventh aspect, the technology disclosed in the present specification provides a non-transient computer information storage medium containing program instructions that when executed by a computer processor of at least one server for supplying information retrieved from the Internet to a client device effect:

a receiving, by at the least one server from the client device, of a search query to be searched;

an effecting, by the at least one server, of a search in respect of the search query;

a sending, by the at least one server to the client device, of search results in respect of the search query, and of instructions to the client device to display the search results on a search engine results page within a web browser on the client device, the search results including at least an ordered series of hyperlinks pointing to Internet resources;

a receiving, by the at least one server from the client device, of instructions for furnishing the client device with an Internet resource to which a user-selected one of the ordered series of hyperlinks points; and

a sending, by the at least one server to the client device, of instructions to reorganize the display of the search engine results page within the web browser on the client device, of the user-selected Internet resource, and of instructions to display the user-selected Internet resource on the client device within the web browser in visual proximity to the reorganized search engine results page while continuing to display the reorganized search engine results page.

According to a twelfth aspect, the technology disclosed in the present specification provides a non-transient computer information storage medium containing program instructions that when executed by a computer processor of at least one server for supplying information retrieved from the Internet to a client device effect:

a receiving, by at the least one server from the client device, of a search query to be searched;

an effecting, by the at least one server, of a search in respect of the search query;

a sending, by the at least one server to the client device, of search results in respect of the search query, and of instructions to the client device to display the search results on a search engine results page within a web browser on the client device, the search results including at least an ordered series of hyperlinks pointing to Internet resources; and

a sending, by the at least one server to the client device, of an Internet resource to which a first one of the ordered series of hyperlinks points, and of instructions to display the Internet resource within the web browser in visual proximity to the search engine results page, while continuing to display the search engine results page, without the at least one server having received user-initiated instructions to furnish the Internet resource.

Embodiments of the present disclosure each have at least one of the above-mentioned object and/or aspects, but do not necessarily have all of them. It should be understood that some aspects of the present disclosure that have resulted from attempting to attain the above-mentioned object may not satisfy this object and/or may satisfy other objects not specifically recited herein.

Additional and/or alternative features, aspects, and advantages of embodiments of the present disclosure will become apparent from the following description, the accompanying drawings, and the appended claims.

### BRIEF DESCRIPTION OF THE DRAWINGS

For a better understanding of the present disclosure, as well as other aspects and further features thereof, reference is made to the following description which is to be used in conjunction with the accompanying drawings, where:

FIG. 1 is a sequence diagram showing steps of a method of retrieving information from the Internet without auto-display of first ranked results according to an embodiment;

FIG. 2 is a sequence diagram showing steps of a method of retrieving information from the Internet with auto-display of first ranked results according to another embodiment;

FIG. 3 is a sequence diagram showing steps of a method of supplying information retrieved from the Internet to a client device without auto-display of first ranked results according to a further embodiment;

FIG. 4 is a sequence diagram showing steps of a method of supplying information retrieved from the Internet to a client device with auto-display of first ranked results according to yet another embodiment;

FIG. 5 is an illustrative web browser display area for showing search results in respect of a search query;

FIG. 6 is an illustrative web browser display area for concurrently showing two separate contents on a client device, in accordance with the methods of FIGS. 1-4;

FIG. 7 is block diagram of a client system configured for retrieving information from the Internet; and

FIG. 8 is a block diagram of a server system configured for supplying information retrieved from the Internet to a client device.

### DETAILED DESCRIPTION

According to the present disclosure, search results including a series of hyperlinks and an Internet resource designated by a user selected hyperlink are received at a client device, from one or more servers, and are concurrently displayed on distinct columns of a web browser display area. As expressed in more details hereinbelow, the client device receives from a server (or from one or more servers) a list of search results in response to a search query. The list of search results may be initially displayed on a browser display area of the client device, for example in an ordered list with a most relevant search result being displayed at the top of the list. The user selects a given search result. The client device responds to the user selection by sending to the server a request for an Internet resource, e.g. a web page. The server provides the Internet resource to the client device. The client device reorganizes the display of the search results in order to create a browser display area partition for showing the search results and another browser display area partition for showing the Internet resource. Hence the list of search results and the selected Internet resource both appear concurrently on the display, for example in side by side partitions. Both partitions act as fully functional web pages and the user may select hyperlinks in either of the partitions for further browsing.

In an embodiment, partitioning of the browser display area may take place before selection of an Internet resource by the user. Instead, the client device may show the list of search results in one partition and an Internet resource corresponding to a highest ranked of the search results in another partition. Of course, the user may still select another result from the list of search results in order to request another Internet resource for display thereof concurrently with the list of search results.

Program instructions may be stored in a non-transient memory of the client device for support of partitioning of its browser display area for concurrent display of the list of search results and of an Internet resource. Alternatively, the server that provides the list of search results and the Internet resource to the client device may be configured to further provide instructions for display of the search results concurrently with the Internet resource; in such a variant, the server includes program instructions for providing to the client device the search results and the Internet resource configured as if they collectively formed parts of a same web page.

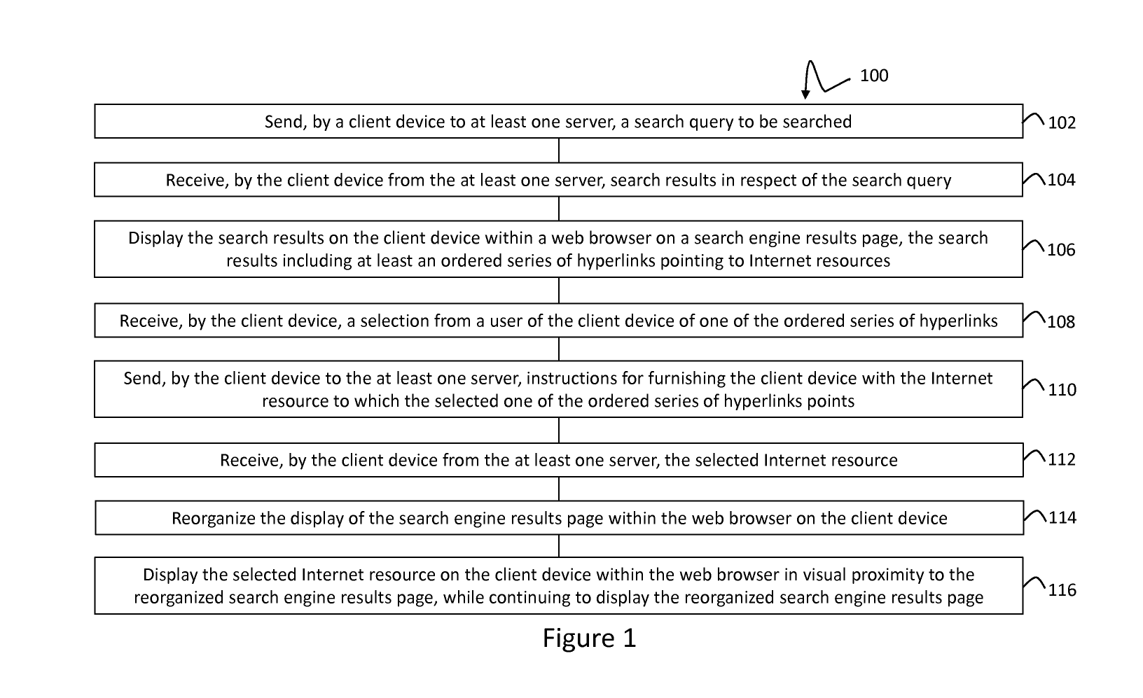

FIGS. 1-4 and their description recite methods for retrieving information from the Internet and for displaying the information on a client device, according to the following embodiments:

A) display by a client device of a list of search results at first, followed by a display of a user selected Internet resource in visual proximity of the list of search results;

B) display by a client device of a list of search results in visual proximity of an Internet resource corresponding to a first one of the list of search results, without user selection;

C) instructions from a server to the client device to display a list of search results at first, followed by a display of a user selected Internet resource in visual proximity of the list of search results; and

D) instructions from a server to the client device to display a list of search results in visual proximity of an Internet resource corresponding to a first one of the list of search results, without user selection.

FIG. 1 is a sequence diagram showing steps of a method of retrieving information from the Internet without auto-display of first ranked results according to an embodiment. A sequence 100 comprises a plurality of steps, some of which may be executed in a variable order, some of the steps possibly being executed concurrently. The sequence 100 comprises a step 102 of sending, by a client device to at least one server, a search query to be searched. At step 104, the client device receives search results in respect of the search query from the at least one server. A display of the search results on the client device within a web browser on a search engine results page follows at step 106, the search results including at least an ordered series of hyperlinks pointing to Internet resources. The client device receives, at step 108, a selection from a user of the client device of one of the ordered series of hyperlinks. The client device sends, to the at least one server, instructions for furnishing the client device with the Internet resource to which the selected one of the ordered series of hyperlinks points at step 110. The client device receives the selected Internet resource from the at least one server at step 112. A reorganization of the display of the search engine results page within the web browser on the client device is made at step 114. A display is made at step 116 of the selected Internet resource on the client device within the web browser in visual proximity to the reorganized search engine results page, while continuing to display the reorganized search engine results page.

It is to be understood that the search results received by the client device at step 104 and displayed at step 106 may not necessarily represent an actual search page, but may rather comprise actual hyperlinks, received in a format allowing their display within the web browser of the client device.

Variants of the method illustrated in FIG. 1 may comprise one or more of the following features, in various combinations. In a first variant, reorganization of the display of the search engine results page within the web browser on the client device includes highlighting the selected one of the ordered series of hyperlinks.

In a second variant, reorganization of the display of the search engine results page within the web browser on the client device includes a display of the search engine results page within a first column within the web browser on the client device. Additionally, a display of the selected Internet resource on the client device within the web browser in visual proximity to the reorganized search engine results page, while continuing to display the reorganized search engine results page, includes displaying the selected Internet resource on the client device within the web browser in a second column adjacent the first column. It is understood that the reorganization of the display of the search engine results page within the web browser on the client device may include a display of the search engine results page within a first row within the web browser on the client device or within a first space within the web browser on the client device. It is also understood that a display of the selected Internet resource on the client device within the web browser in visual proximity to the reorganized search engine results page, may include displaying the selected Internet resource on the client device within the web browser in a second row adjacent the first row or in a second space adjacent the first space.

In a third variant, after displaying the selected Internet resource on the client device within the web browser in visual proximity to the reorganized search engine results page, while continuing to display the reorganized search engine results page, the client device receives a selection from the user of the client device of a sub-resource of the selected Internet resource. The client device sends instructions for furnishing the client device with the selected sub-resource to the at least one server. The client device receives the selected sub-resource from the at least one server. A display is made of the selected sub-resource on the client device within the web browser in place of the selected Internet resource, while continuing to display the reorganized search engine results page.

In a fourth variant, after displaying the selected Internet resource on the client device within the web browser in visual proximity to the reorganized search engine results page, while continuing to display the reorganized search engine results page, the client device receives a selection from the user of the client device of a sub-resource of the selected Internet resource. The client device sends instructions for furnishing the client device with the selected sub-resource to the at least one server. The client device receives the selected sub-resource from the at least one server. Reorganization is made of the display of at least one of the search engine results page and of the selected Internet resource within the web browser on the client device. A display is made of the selected sub-resource on the client device within the web browser in visual proximity to the search engine results pages and the selected Internet resource, while continuing to display the search engine results page and the selected Internet resource.

In a fifth variant, the client device receives an additional selection from the user of the client device of another one of the ordered series of hyperlinks. The client device sends, to the at least one server, instructions for furnishing the client device with the Internet resource to which the additional selected one of ordered series of hyperlinks points. The client device receives the additional selected Internet resource from the at least one server. A display is made of the additional selected Internet resource on the client device within the web browser in place of the Internet resource, while continuing to display the reorganized search engine results page.

In a sixth variant, the client device receives an additional selection from the user of the client device of another one of the ordered series of hyperlinks. The client device sends, to the at least one server, instructions for furnishing the client device with the Internet resource to which the additional selected one of ordered series of hyperlinks points. The client device receives the additional selected Internet resource from the at least one server. Reorganization is made of the display of at least one of the search engine results page and of the selected Internet resource on the client device. A display is made of the additional selected Internet resource on the client device within the web browser in visual proximity to the search engine results page and the selected Internet resource, while continuing to display the search engine results page and the selected Internet resource.

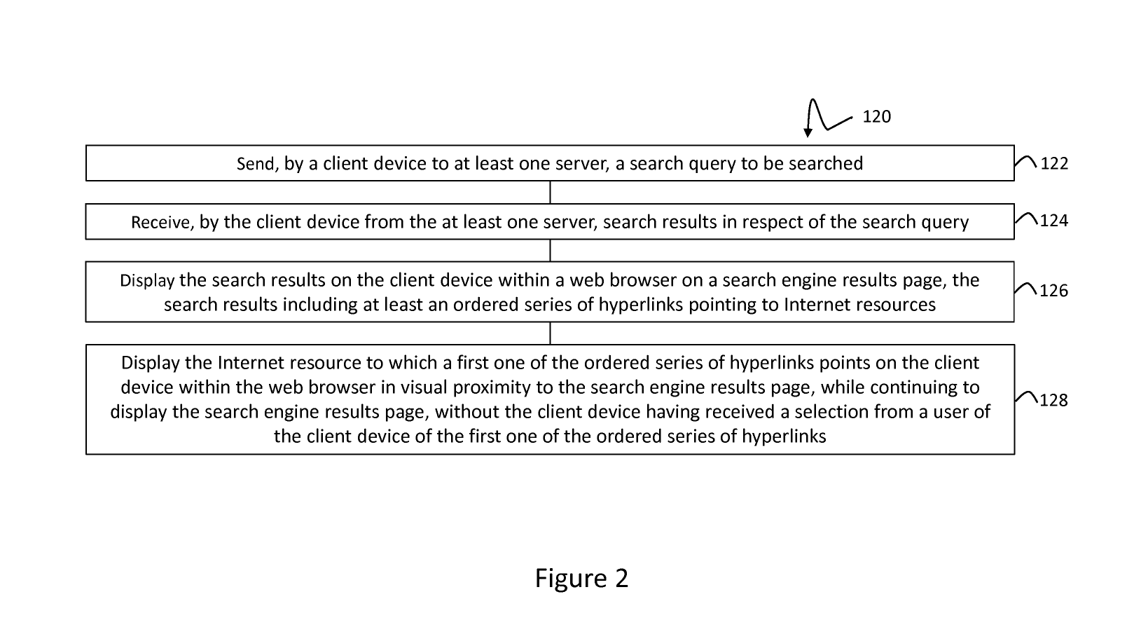

In the sequence 100 of FIG. 1, the client device initially displays the search results and further displays a selected Internet resource according to a selection by the user. In an alternate embodiment, a highest ranked result of a search query may be displayed concurrently with the initial display of the search results, before an actual user selection of a search result. FIG. 2 is a sequence diagram showing steps of a method of retrieving information from the Internet with auto-display of first ranked result according to another embodiment. A sequence 120 comprises a plurality of steps, some of which may be executed in a variable order, some of the steps possibly being executed concurrently. The sequence 120 comprises a step 122 of sending, by a client device to at least one server, a search query to be searched. At step 124, the client device receives search results in respect of the search query from the at least one server. A step 126 of displaying the search results on the client device within a web browser on a search engine results page follows, the search results including at least an ordered series of hyperlinks pointing to Internet resources. A display is made at step 128 of the Internet resource to which a first one of the ordered series of hyperlinks points on the client device within the web browser in visual proximity to the search engine results page, while continuing to display the search engine results page, without the client device having received a selection from a user of the client device of the first one of the ordered series of hyperlinks.

Variants of the method illustrated in FIG. 2 may comprise one or more of the following features, in various combinations. In a first variant, the first one of the ordered series of hyperlinks is highlighted.

In a second variant, the display of the search results on the client device within a web browser on a search engine results page includes a display of the search engine results page within a first column within the web browser on the client device. Additionally, the display of the Internet resource to which the first one of the ordered series of hyperlinks points on the client device within the web browser in visual proximity to the search engine results page, while continuing to display the search engine results page, without the client device having received a selection from the user of the client device of the first one of the ordered series of hyperlinks includes a display of the Internet resource to which the first one of the ordered series of hyperlinks points on the client device within the web browser in a second column adjacent the first column.

In a third variant, the client device receives, from the user of the client device, a selection of a sub-resource of the Internet resource to which the first one of the ordered series of hyperlinks points. The client device sends instructions for furnishing the client device with the selected sub-resource to the at least one server. The client device receives the selected sub-resource from the at least one server. A display is made of the selected sub-resource on the client device within the web browser in place of the Internet resource to which the first one of the ordered series of hyperlinks points, while continuing to display the search engine results page.

In a fourth variant, the client device receives, from the user of the client device, a selection of a sub-resource of the Internet resource to which the first one of the ordered series of hyperlinks points. The client device sends instructions for furnishing the client device with the selected sub-resource to the at least one server. The client device receives the selected sub-resource from the at least one server. Reorganization is made of the display of at least one of the search engine results page and of the display of the Internet resource to which the first one of the ordered series of hyperlinks points within the web browser on the client device. A display is made of the selected sub-resource on the client device within the web browser in visual proximity to the search engine results pages and the Internet resource to which the first one of the ordered series of hyperlinks points, while continuing to display the search engine results page and the Internet resource to which the first one of the ordered series of hyperlinks points.

In a fifth variant, the client device receives, from the user of the client device, a selection of one of the ordered series of hyperlinks other than the first one. The client device sends, to the at least one server, instructions for furnishing the client device with the Internet resource to which the selected one of ordered series of hyperlinks points. The client device receives the selected Internet resource from the at least one server. A display is made of the selected Internet resource on the client device within the web browser in place of the Internet resource to which the first one in the series of ordered hyperlinks points, while continuing to display the search engine results page.

In a sixth variant, the client device receives, from the user of the client device, a selection of one of the ordered series of hyperlinks other than the first one. The client device sends, to the at least one server, instructions for furnishing the client device with the Internet resource to which the selected one of ordered series of hyperlinks points. The client device receives the selected Internet resource from the at least one server. Reorganization is made of the display on the client device of at least one of the search engine results page and of the Internet resource to which the first of the ordered series of hyperlinks points. A display is made of the additional selected Internet resource on the client device within the web browser in visual proximity to the search engine results page and the Internet resource to which the first of the ordered series of hyperlinks points, while continuing to display the search engine results page and the Internet resource to which the first of the ordered series of hyperlinks points.

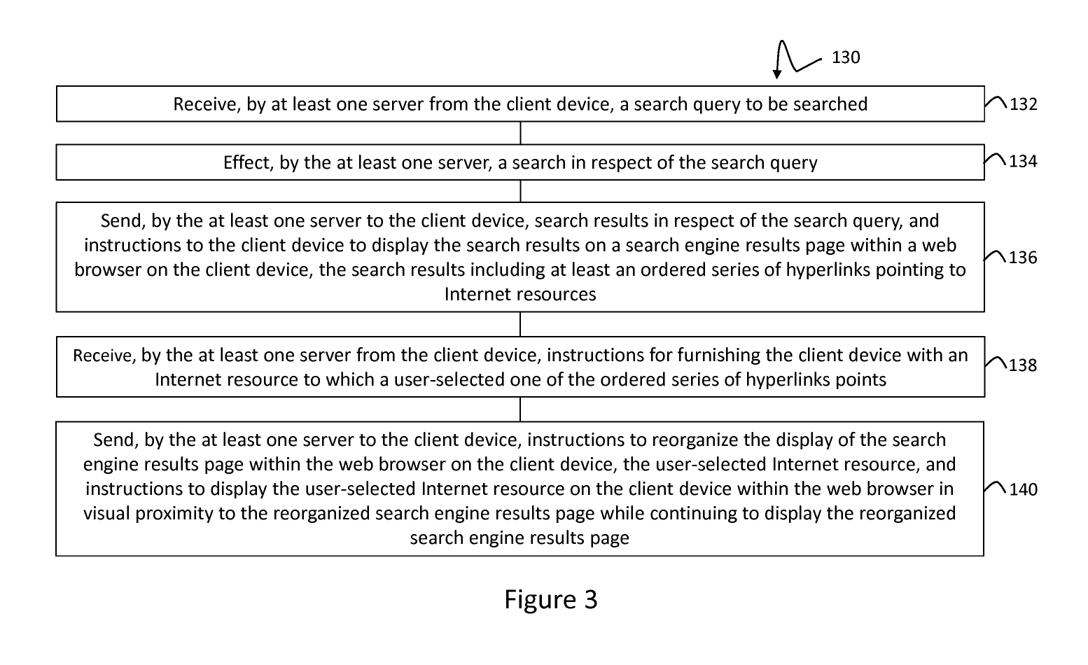

Some client devices may have the capability to autonomously display received search results and Internet resources in one or more of the manners illustrated in the sequences of FIGS. 1 and 2. This autonomous capability may for example be supported by specific software implemented in client devices, including for example the web browser software, an installable add-on to the browser software, or a mobile application. In another aspect, one or more server may provide instructions to a client device displaying search results and Internet resources as described hereinabove, enabling display of search results and of Internet results in one or more of the manners described hereinabove on a client device equipped with ordinary web browser software. FIG. 3 is a sequence diagram showing steps of a method of supplying information retrieved from the Internet to a client device without auto-display of first ranked results according to a further embodiment. A sequence 130 comprises a plurality of steps, some of which may be executed in a variable order, some of the steps possibly being executed concurrently. The sequence 130 comprises a step 132 of receiving, by at least one server from the client device, a search query to be searched. A search in respect of the search query is effected, by the at least one server, at step 134. At step 136, the at least one server sends, to the client device, search results in respect of the search query, and instructions to the client device to display the search results on a search engine results page within a web browser on the client device, the search results including at least an ordered series of hyperlinks pointing to Internet resources. The at least one server receives at step 138, from the client device, instructions for furnishing the client device with an Internet resource to which a user-selected one of the ordered series of hyperlinks points. At step 140, the at least one server sends, to the client device, instructions to reorganize the display of the search engine results page within the web browser on the client device, the user-selected Internet resource, and instructions to display the user-selected Internet resource on the client device within the web browser in visual proximity to the reorganized search engine results page while continuing to display the reorganized search engine results page.

Variants of the method illustrated in FIG. 3 may comprise one or more of the following features, in various combinations. In a first variant, the sending, by the at least one server to the client device, of instructions to reorganize the display of the search engine results page within the web browser on the client device, of the user-selected Internet resource, and of instructions to display the user-selected Internet resource on the client device within the web browser in visual proximity to the reorganized search engine results page while continuing to display the reorganized search engine results page, includes a sending, by the at least one server to the client device, of instructions to display the search engine results page within a first column within the web browser on the client device, of the user-selected Internet resource, and of instructions to display the user-selected Internet resource within a second column adjacent the first column.

In a second variant, after sending, by the at least one server to the client device, instructions to reorganize the display of the search engine results page within the web browser on the client device, the user-selected Internet resource, and instructions to display the user-selected Internet resource on the client device within the web browser in visual proximity to the reorganized search engine results page while continuing to display the reorganized search engine results page, the at least one server receives, from the client device, instructions for furnishing the client device with a user-selected sub-resource of the Internet resource. The at least one server sends, to the client device, the user-selected sub-resource of the Internet resource and instructions to display the user-selected sub-resource on the client device within the web browser in place of the Internet resource while continuing to display the reorganized search engine results page.

In a third variant, after sending, by the at least one server to the client device, instructions to reorganize the display of the search engine results page within the web browser on the client device, the user-selected Internet resource, and instructions to display the user-selected Internet resource on the client device within the web browser in visual proximity to the reorganized search engine results page while continuing to display the reorganized search engine results page, the at least one server receives, from the client device, instructions for furnishing the client device with a user-selected sub-resource of the Internet resource. The at least one server sends, to the client device, instructions to reorganize the display of at least one of the search engine results page and the Internet resource within the web browser on the client device, the user-selected sub-resource, and instructions to display the user-selected sub-resource on the client device within the web browser in visual proximity to the search engine results page while and the Internet resource, while continuing to display the search engine results page and the Internet resource.

In a fourth variant, the at least one server receives, from the client device, instructions for furnishing the client device with an additional Internet resource to which user-selected another one of the ordered series of hyperlinks points. The at least one server sends, to the client device, the additional Internet resource and instructions to display the additional Internet resource within the web browser in place of the Internet resource while continuing to display the reorganized search engine results page.

In a fifth variant, the at least one server receives, from the client device, instructions for furnishing the client device with an additional Internet resource to which user-selected another one of the ordered series of hyperlinks points. The at least one server sends, to the client device, instructions to reorganize the display of at least one of the search engine results page and the Internet resource within the web browser on the client device, the additional Internet resource, and instructions to display the additional Internet resource on the client device within the web browser in visual proximity to the search engine results page and the Internet resource, while continuing to display the search engine results page and the Internet resource.

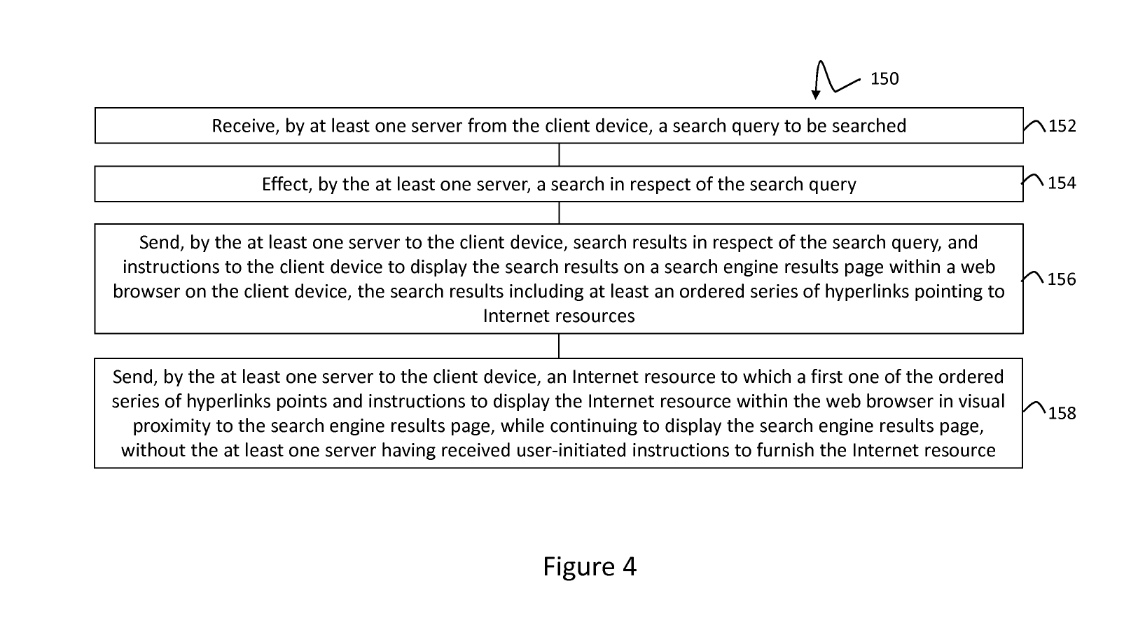

In the sequence 300 of FIG. 3, instructions provided to the client device allow to initially display the search results and to further display a selected Internet resource according to a selection by the user. In an alternate embodiment, instructions provided to the client allow a highest ranked result of a search query to be displayed concurrently with the initial display of the search results. FIG. 4 is a sequence diagram showing steps of a method of supplying information retrieved from the Internet to a client device with auto-display of first ranked results according to yet another embodiment. A sequence 150 comprises a plurality of steps, some of which may be executed in a variable order, some of the steps possibly being executed concurrently. The sequence 150 comprises a step 152 of receiving, by at least one server from the client device, a search query to be searched. The at least one server effects a search in respect of the search query at step 154. At step 156, the at least one server sends, to the client device, search results in respect of the search query, and instructions to the client device to display the search results on a search engine results page within a web browser on the client device, the search results including at least an ordered series of hyperlinks pointing to Internet resources. The at least one server sends, to the client device at step 158, an Internet resource to which a first one of the ordered series of hyperlinks points and instructions to display the Internet resource within the web browser in visual proximity to the search engine results page, while continuing to display the search engine results page, without the at least one server having received user-initiated instructions to furnish the Internet resource.

Variants of the method illustrated in FIG. 4 may comprise one or more of the following features, in various combinations. In a first variant, the sending, by the at least one server to the client device, of search results in respect of the search query, and of instructions to the client device to display the search results on a search engine results page within a web browser on the client device includes a sending, by the at least one server to the client, of search results in respect of the search query, and of instructions to the client device to display the search results on a search engine results page within a first column within the web browser on the client device. The sending, by the at least one server to the client device, of an Internet resource to which the first one of the ordered series of hyperlinks points and of instructions to display the Internet resource within the web browser in visual proximity to the search engine results page, while continuing to display the search engine results page, without the at least one server having received user-initiated instructions to furnish the Internet resource includes a sending, by the at least one server to the client device, of an Internet resource to which the first of the ordered series of hyperlinks points, and of instructions to display the Internet resource in a second column adjacent the first column.

In a second variant, the at least one server receives, from the client device, instructions for furnishing the client device with a user-selected sub-resource of the Internet resource. The at least one server sends, to the client device, the user-selected sub-resource of the Internet resource, and instructions to display the user-selected sub-resource within the web browser in place of the Internet resource while continuing to display the search engine results page.

In a third variant, the at least one server receives, from the client device, instructions for furnishing the client device with a user-selected sub-resource of the Internet resource. The at least one server sends, to the client device, instructions to reorganize the display of at least one of the search engine results page and the Internet resource within the web browser on the client device, the user-selected sub-resource, and instructions to display the user-selected sub-resource on the client device within the web browser in visual proximity to the search engine results page and the Internet resource while continuing to display the search engine results page and the Internet resource.

In a fourth variant, the at least one server receives, from the client device, instructions for furnishing the client device with an additional Internet resource to which a user-selected another one of the ordered series of hyperlinks points. The at least one server sends, to the client device, the additional Internet resource and instructions to display the additional Internet resource within the web browser in place of the Internet resource while continuing to display the search engine results page.

In a fifth variant, the at least one server receives, from the client device, instructions for furnishing the client device with an additional Internet resource to which a user-selected another one of the ordered series of hyperlinks points. The at least one server sends, to the client device, instructions to reorganize the display of at least one of the search engine results page and of the

Internet resource within the web browser on the client device, the additional Internet resource, and instructions to display the additional Internet resource on the client device within the web browser in visual proximity to the search engine results page and the Internet resource while continuing to display the search engine results page and the Internet resource.

Display of search results and reorganization of the display of search results and of

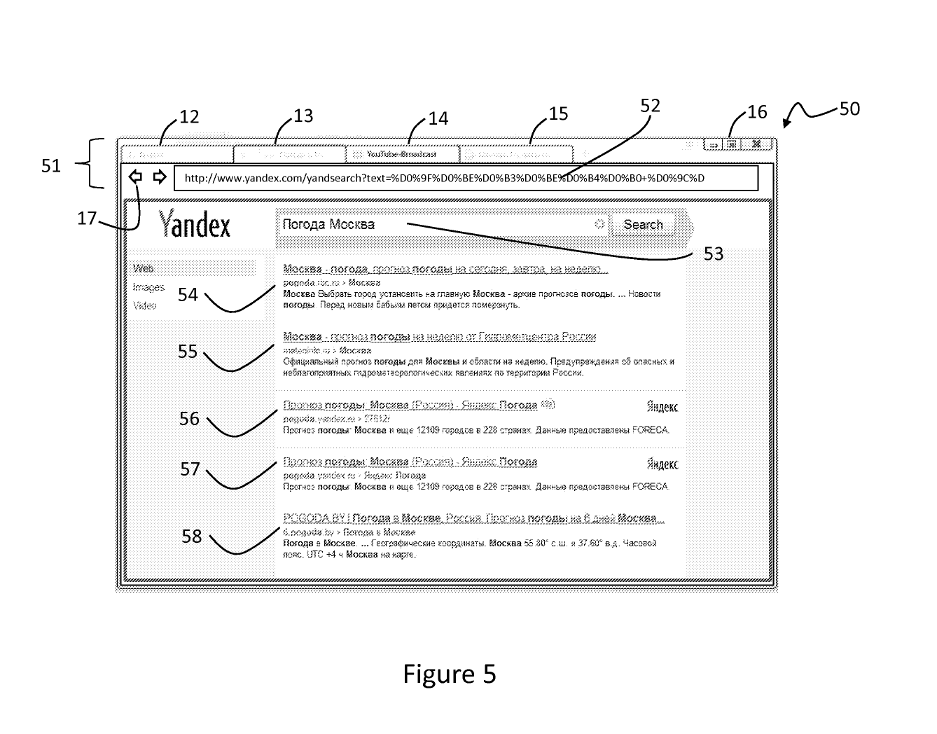

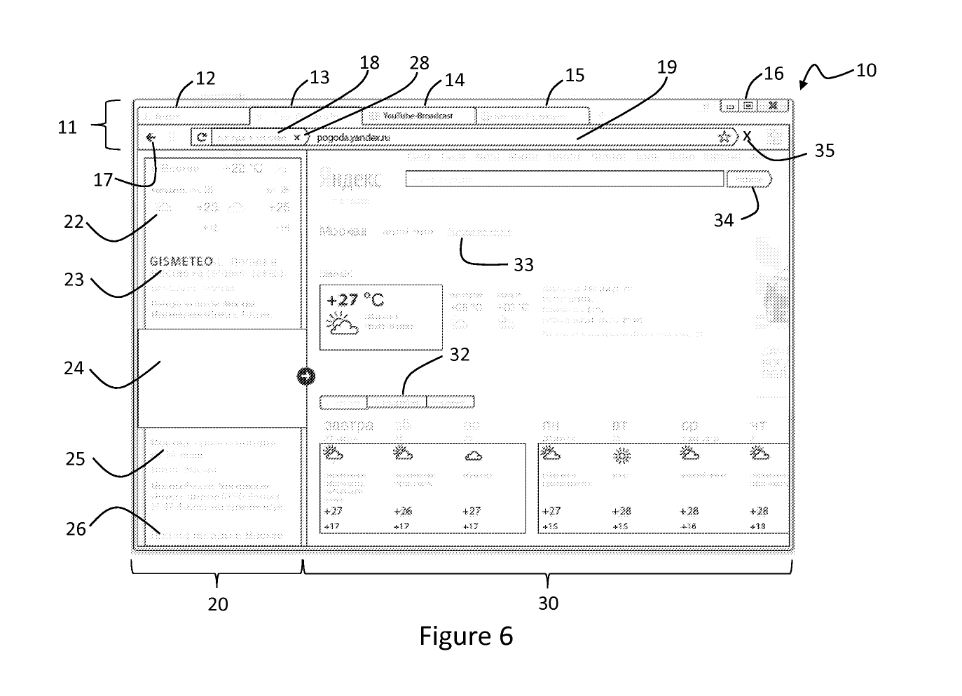

Internet resources, as described hereinabove, will be better understood by reference to FIGS. 5 and 6.

FIG. 5 is an illustrative web browser display area for showing search results in respect of a search query. A web browser display area 50 becomes visible on the client device display, after reception of search results by the client device, for example at step 106 of FIG. 1, or following sending of search results, to the client device, by the server, for example after step 136 of FIG. 3. The web browser display area 50 shows a toolbar 51 that may comprise several conventional elements, including one or more opened tabs such as 12, 13, 14 and 15, the tab 13 being highlighted on FIG. 5 since it corresponds to the currently displayed contents of the web browser display area 50. Well-known tools 16 for minimizing, maximizing or closing the web browser display area 10 and well-known arrows 17 for moving back and forth between web pages may be provided. The toolbar 51 shows an address 52 generated by the search engine for delivery of the search results. Besides the toolbar 51, the web browser display area 50 shows results 54, 55, 56, 57 and 58 of a search for keywords “Πoro [symbol] a MocκBa” 53 that were used in a search query related to the weather in Moscow. The search results 54, 55, 56, 57 and 58 form an ordered series of hyperlinks pointing to Internet resources that a user may select in order to request display of a corresponding Internet resource.

FIG. 6 is an illustrative web browser display area for concurrently showing two separate contents on a client device, in accordance with the methods of FIGS. 1-4. A structure of the web browser display area 10 may be defined, at least in part, by instructions received at the client device from a server. Alternatively, the structure of the web browser display area 10 may be defined, at least in part, by program instructions residing within the client device.

The web browser display area 10 becomes visible on the client device display after reception by the client device of the selected Internet resource from the server and after reorganization of the display of the search engine results page of the web browser display area 50, for example after steps 112 and 114 of FIG. 1, or following sending of an Internet resource and of display instructions, by the server to the client device, for example after step 140 of FIG. 3. The web browser display area 10 differs from the web browser display area 50 of FIG. 5 in several ways. The web browser display area 10 comprises a toolbar 11, which is somewhat modified from the toolbar 51 of FIG. 5, a first column 20, which may be called a first partition or a first frame, and a second column 30, which may be called a second partition or a second frame. Without limitation, the column 20 may be dedicated to showing a list of search results and the column 30 may autonomously display an Internet resource corresponding to a highest ranked search result or may display a user selected Internet resource.

The toolbar 11 may comprise several conventional elements, including one or more opened tabs such as 12, 13, 14 and 15, the tab 13 being highlighted on FIG. 6 since it corresponds to the currently displayed contents of the columns 20 and 30. The well-known tools 16 for minimizing, maximizing or closing the web browser display area 10 and the well-known arrows 17 for moving back and forth between web pages may be provided.

An address bar may now be split into two fields, including a search query field 18, corresponding to the column 20, and a selected Internet resource address field 19, corresponding to the column 30. In a variant, the address bar may show one single field, for example showing the selected Internet resource address field 19.

In the example of FIG. 6, the column 20 shows hyperlinks resulting from a search query related to the weather in Moscow. The search query field 18 lists keywords “Πoro [symbol] a MocκBa” that were used in the search query. A search engine has provided a custom field 22, showing weather information suggested by the search engine, and search results 23-26. A user has selected a search result 24, which is highlighted within the column 20. As shown, highlighting of the search result 24 may comprise zooming in of an area showing this result 24, and adding an arrow pointing to the column 30. Other manners of highlighting the selected search result 24 may comprise greying of all non-selected search results, modifying fonts of the result 24, or any other suitable manner that may be envisioned by those of ordinary skill in the art. Right of the search query field 18, a cross-shaped user-selectable icon 28 may be selected by the user for closing the column 20, whereby the entire web browser display area 10, exclusive of the toolbar 11, may become available to show the column 30.

The column 30 shows an Internet resource, for example a web page, provided by a server having an address “pogoda.yandex.ru”, as indicated in the selected Internet resource address field 19. The Internet resource may have been provided directly by the server having the address “pogoda.yandex.ru”, or by a server having provided the search results 23-26. The column 30 generally shows same contents and fields as would be provided on a conventional client device display if a user had entered the address “pogoda.yandex.ru” in an address bar of a conventional browser. Some fields of the column 30, for example fields 32, 33 and 34, provide links to further web pages and are user-selectable in a conventional manner. Right of the selected Internet resource address field 19, another cross-shaped user-selectable icon 35 may be selected by the user for closing the column 30, whereby the entire web browser display area 10, exclusive of the toolbar 11, may become available to show the contents of the column 20.

User selection of a search result in the column 20 in order to request an Internet resource, allows the user to at once navigate within a web page appearing in the column 30 and in the search results display in the column 20. In fact, both columns represent functional web sites that allow redirection according to hyperlinks that they may contain.

As illustrated, the Internet resource content displayed within the column 30 appears truncated on its right hand side. This may be indicative of a web page content originally formatted for a full-width browser; evidently, presence of the column 20 does consume some width of the client device's display. Regardless, the contents delivered to the client device for display within the column 30 is complete and fully operational.

As illustrated, the column 20 is smaller than the column 30, the columns 20 and 30 are adjacent, and the results column 20 is shown on the left of the selected search result column 30. This arrangement is conveniently displayed on some screen formats, for example in a landscape format, but is not exclusive and may be modified according to the needs of a specific application. Of course, numerous modifications could be brought to the web browser display area 10 of FIG. 6, including modifying dimensions, positions and shapes of any illustrated element. FIG. 6 is therefore illustrative and is not meant to limit the scope of the present disclosure.

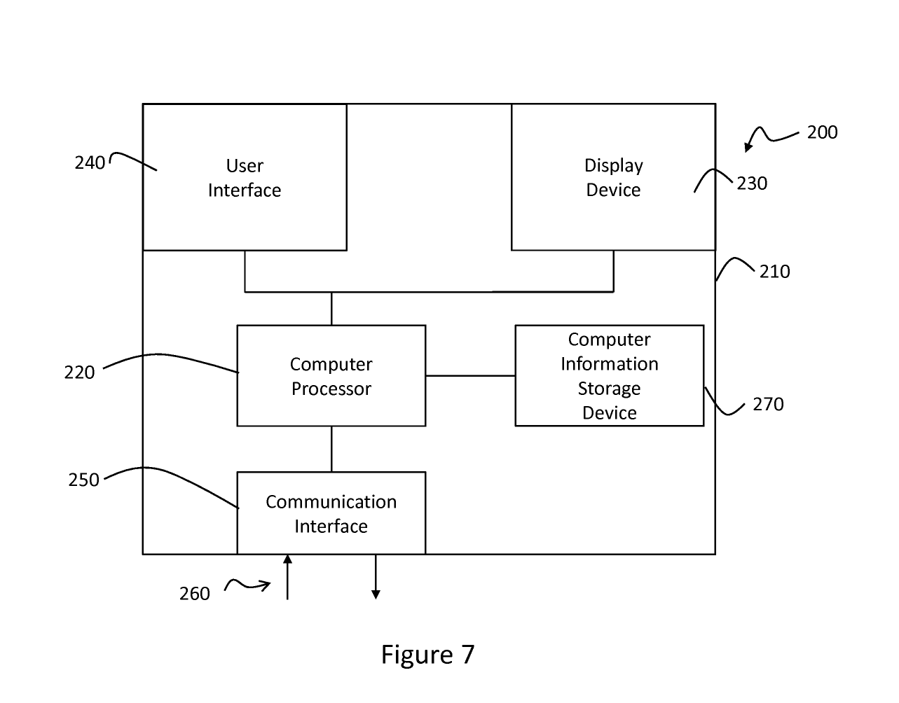

The methods of FIGS. 1 and 2 and the web browser display areas of FIGS. 5 and 6 may be implemented in a client system comprising a client device as described in FIG. 7.

FIG. 7 is block diagram of a client system configured for retrieving information from the Internet. A system 200 comprises a client device 210 that includes a computer processor 220, a display device 230, a user interface 240, a communication interface 250 and a non-transient computer information storage device 270. The communication interface 250 is structured and configured to communicate bi-directionally 260 with at least one server. The display device 230, the user interface 240, the communication interface 250 and the non-transient computer information storage device 270 are all operationally connected with the computer processor 220.

Though the display device 230 and the user interface 240 are shown on FIG. 7 as two distinct elements, the client device 210 may comprise, in a non-limiting variant, a touch-sensitive screen acting at once as a display and as a user interface. Hence, the display device 230 and the user interface 240 may be combined in a single entity and are shown as distinct entities for illustration purposes without limiting the present disclosure.

In one or more variants, the client device 210 of FIG. 7 may comprise, without limitation, a desktop computer, a laptop computer, a notebook, a tablet computer, a cellular phone, an intelligent terminal, a smartphone, a portable media player, or a personal digital assistant.

The computer information storage device 270 contains program instructions. When executed by the computer processor 210, the program instructions can effect a sending, by the client device 210 to the at least one server, of a search query to be searched, a receiving, by the client device 210 from the at least one server, of search results in respect of the search query, a display of the search results on the client device 210 within a web browser on a search engine results page, the search results including at least an ordered series of hyperlinks pointing to Internet resources, a receiving, by the client device 210, of a selection from a user of the client device 210 of one of the ordered series of hyperlinks, a sending, by the client device 210 to the at least one server, of instructions for furnishing the client device 210 with the Internet resource to which the selected one of the ordered series of hyperlinks points, a receiving, by the client device 210 from the at least one server, of the selected Internet resource, a reorganization of the display of the search engine results page within the web browser on the client device 210, and a display of the selected Internet resource on the client device 210 within the web browser in visual proximity to the reorganized search engine results page, while continuing to display the reorganized search engine results page.

Alternatively, execution of the program instructions by the computer processor 210 can effect a sending, by the client device 210 to the at least one server, of a search query to be searched, a receiving, by the client device 210 from the at least one server, of search results in respect of the search query, a display of the search results on the client device 210 within a web browser on a search engine results page, the search results including at least an ordered series of hyperlinks pointing to Internet resources, and a display of the Internet resource to which a first one of the ordered series of hyperlinks points on the client device 210 within the web browser in visual proximity to the search engine results page, while continuing to display the search engine results page, without the client device 210 having received a selection from a user of the client device 210 of the first one of the ordered series of hyperlinks.

The client device 210 of FIG. 7 is further capable of supporting all features of the methods of FIGS. 1 and 2, in any combination.

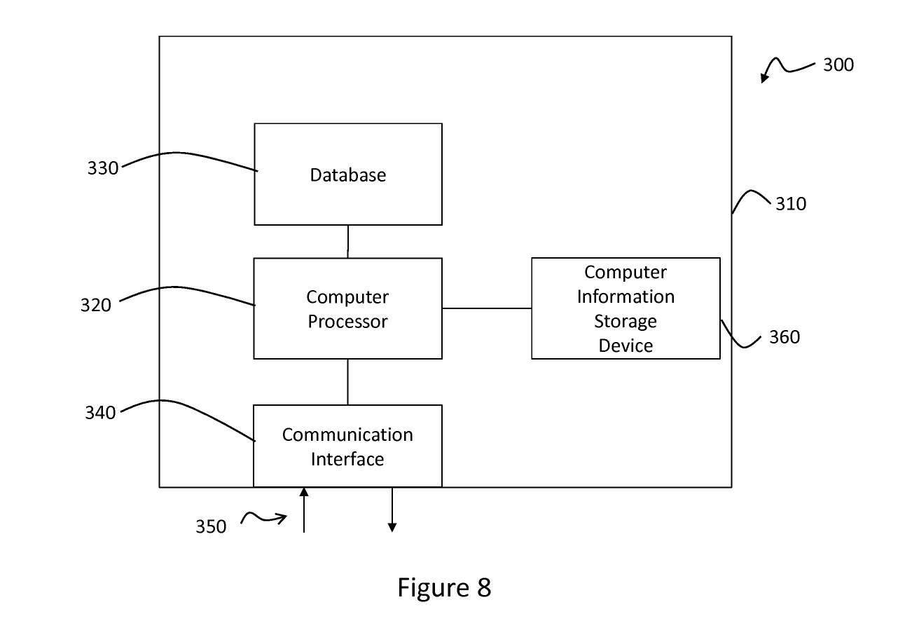

The methods of FIGS. 3 and 4 and instructions to a client device for support of the web browser display areas of FIGS. 5 and 6 may be implemented in a client system comprising a one or more servers as described in FIG. 8.

FIG. 8 is a block diagram of a server system configured for supplying information retrieved from the Internet to a client device. A system 300 comprises at least one server 310 that includes a computer processor 320, a database 330, a communication interface 340 and a computer information storage device 360. The database 330 contains the information retrieved from the Internet. The communication interface 340 is structured and configured to communicate bi-directionally 350 with the client device. The database 330, the communication interface 340 and the computer information storage device 360 are all operationally connected with the computer processor 320.

FIG. 8 shows the system 300 including a single server 310. Embodiments of the system 300 may include a plurality of servers 310. The information retrieved from the Internet may be replicated in databases 330 of each server 310. Alternatively, the information retrieved from the

Internet may be split into partitions, also called shards, each database 330 containing one or more shard, the databases 330 of a plurality of servers 310 collectively containing the information retrieved from the Internet. Hence, a plurality of servers 310 may serve a large number of client devices, in load sharing fashion, in redundant fashion, or both in load-sharing and redundant fashion. Those of ordinary skill in the art having the benefit of the present disclosure will be able to provision the system 300 for supporting a large number of client devices.

The computer information storage device 360 contains program instructions. When executed by the computer processor 320, the program instructions can effect a receiving, by at the least one server 310 from the client device, of a search query to be searched, an effecting, by the at least one server 310, of a search in respect of the search query, a sending, by the at least one server 310 to the client device, of search results in respect of the search query, and of instructions to the client device to display the search results on a search engine results page within a web browser on the client device, the search results including at least an ordered series of hyperlinks pointing to Internet resources, a receiving, by the at least one server 310 from the client device, of instructions for furnishing the client device with an Internet resource to which a user-selected one of the ordered series of hyperlinks points, and a sending, by the at least one server 310 to the client device, of instructions to reorganize the display of the search engine results page within the web browser on the client device, of the user-selected Internet resource, and of instructions to display the user-selected Internet resource on the client device within the web browser in visual proximity to the reorganized search engine results page while continuing to display the reorganized search engine results page.

Alternatively, execution of the program instructions by the computer processor 320 can effect a receiving, by at the least one server 310 from the client device, of a search query to be searched, an effecting, by the at least one server 310, of a search in respect of the search query, a sending, by the at least one server 310 to the client device, of search results in respect of the search query, and of instructions to the client device to display the search results on a search engine results page within a web browser on the client device, the search results including at least an ordered series of hyperlinks pointing to Internet resources, and a sending, by the at least one server 310 to the client device, of an Internet resource to which a first one of the ordered series of hyperlinks points, and of instructions to display the Internet resource within the web browser in visual proximity to the search engine results page, while continuing to display the search engine results page, without the at least one server 310 having received user-initiated instructions to furnish the Internet resource.

The server 310 of FIG. 8 is further capable of supporting all features of the methods of FIGS. 2 and 3, in any combination. The server 310 is further capable of providing search results, instructions and Internet resources for support of all features of the method of FIGS. 1 and 3 and of the client device 210 of FIG. 7, in any combination.

Modifications and improvements to the above-described embodiments may become apparent to those skilled in the art. The foregoing description is intended to provide implementation examples that are not limiting. The scope of the present disclosure is therefore intended to be limited solely by the scope of the appended claims.

1. A method of retrieving information from the Internet, comprising:
sending, by a client device to at least one server, a search query to be searched;
receiving, by the client device from the at least one server, search results in respect of the search query;
displaying the search results on the client device within a browser display area within a web browser on a search engine results page, the search results including at least an ordered series of hyperlinks pointing to Internet resources;
receiving, by the client device, a selection from a user of the client device of one of the ordered series of hyperlinks;
sending, by the client device to the at least one server, instructions for furnishing the client device with the Internet resource to which the selected one of the ordered series of hyperlinks points;
receiving, by the client device from the at least one server, the selected Internet resource;
reorganizing the display of the search engine results page within the browser display area of the web browser on the client device; and
displaying the selected Internet resource on the client device within the browser display area of the web browser in visual proximity to the reorganized search engine results page, while continuing to display the reorganized search engine results page.

2. The method of claim 1, wherein reorganizing the display of the search engine results page within the browser display area of the web browser on the client device includes highlighting the selected one of the ordered series of hyperlinks.

3. The method of claim 1, wherein:
reorganizing the display of the search engine results page within the browser display area of the web browser on the client device includes displaying the search engine results page within a first column within the browser display area of the web browser on the client device; and
displaying the selected Internet resource on the client device within the browser display area of the web browser in visual proximity to the reorganized search engine results page, while continuing to display the reorganized search engine results page, includes displaying the selected Internet resource on the client device within the browser display area of the web browser in a second column adjacent the first column.

4. The method of claim 1, further comprising, after displaying the selected Internet resource on the client device within the browser displaying area of the web browser in visual proximity to the reorganized search engine results page, while continuing to display the reorganized search engine results page:
receiving, by the client device, a selection from the user of the client device of a sub-resource of the selected Internet resource;
sending, by the client device to the at least one server, instructions for furnishing the client device with the selected sub-resource;
receiving, by the client device from the at least one server, the selected sub-resource; and
displaying the selected sub-resource on the client device within the browser display area of the web browser in place of the selected Internet resource, while continuing to display the reorganized search engine results page.

5. The method of claim 1, further comprising, after displaying the selected Internet resource on the client device within the browser display area of the web browser in visual proximity to the reorganized search engine results page, while continuing to display the reorganized search engine results page:
receiving, by the client device, a selection from the-user of the client device of a sub-resource of the selected Internet resource;
sending, by the client device to the at least one server, instructions for furnishing the client device with the selected sub-resource;
receiving, by the client device from the at least one server, the selected sub-resource;
reorganizing the display of at least one of the search engine results page and the selected Internet resource within the browser display area of the web browser on the client device; and
displaying the selected sub-resource on the client device within the browser display area of the web browser in visual proximity to the search engine results pages and the selected Internet resource, while continuing to display the search engine results page and the selected Internet resource.

6. The method of claim 1, further comprising:
receiving, by the client device, an additional selection from the user of the client device of another one of the ordered series of hyperlinks;
sending, by the client device to the at least one server, instructions for furnishing the client device with the Internet resource to which the additional selected one of ordered series of hyperlinks points;
receiving, by the client device from the at least one server, the additional selected Internet resource; and
displaying the additional selected Internet resource on the client device within the browser display area of the web browser in place of the Internet resource, while continuing to display the reorganized search engine results page.

7. The method of claim 1, further comprising:
receiving, by the client device, an additional selection from the user of the client device of another one of the ordered series of hyperlinks;
sending, by the client device to the at least one server, instructions for furnishing the client device with the Internet resource to which the additional selected one of ordered series of hyperlinks points;
receiving, by the client device from the at least one server, the additional selected Internet resource;
reorganizing the display of at least one of the search engine results page and the selected Internet resource on the client device; and
displaying the additional selected Internet resource on the client device within the browser display area of the web browser in visual proximity to the search engine results page and the selected Internet resource, while continuing to display the search engine results page and the selected Internet resource.

8. (canceled)

9. (canceled)

10. (canceled)

12. (canceled)

13. (canceled)

14. (canceled)

15. A method of supplying information retrieved from the Internet to a client device, comprising:
receiving, by at least one server from the client device, a search query to be searched;
effecting, by the at least one server, a search in respect of the search query;
sending, by the at least one server to the client device, search results in respect of the search query, and instructions to the client device to display the search results on a search engine results page within a browser display area within a web browser on the client device, the search results including at least an ordered series of hyperlinks pointing to Internet resources;
receiving, by the at least one server from the client device, instructions for furnishing the client device with an Internet resource to which a user-selected one of the ordered series of hyperlinks points; and
sending, by the at least one server to the client device, instructions to reorganize the display of the search engine results page within the browser display area of the web browser on the client device, the user-selected Internet resource, and instructions to display the user-selected Internet resource on the client device within the browser display area of the web browser in visual proximity to the reorganized search engine results page while continuing to display the reorganized search engine results page.

16. The method of claim 15, wherein sending, by the at least one server to the client device, instructions to reorganize the display of the search engine results page within the browser display area of the web browser on the client device, the user-selected Internet resource, and instructions to display the user-selected Internet resource on the client device within the browser display area of the web browser in visual proximity to the reorganized search engine results page while continuing to display the reorganized search engine results page, includes sending, by the at least one server to the client device, instructions to display the search engine results page within a first column within the browser display area of the web browser on the client device, the user-selected Internet resource, and instructions to display the user-selected Internet resource within a second column adjacent the first column.

17. The method of claim 15, further comprising, after sending, by the at least one server to the client device, instructions to reorganize the display of the search engine results page within the browser display area of the web browser on the client device, the user-selected Internet resource, and instructions to display the user-selected Internet resource on the client device within the browser display area of the web browser in visual proximity to the reorganized search engine results page while continuing to display the reorganized search engine results page:
receiving, by the at least one server from the client device, instructions for furnishing the client device with a user-selected sub-resource of the Internet resource; and
sending, by the at least one server to the client device, the user-selected sub-resource of the Internet resource and instructions to display the user-selected sub-resource on the client device within the browser display area of the web browser in place of the Internet resource while continuing to display the reorganized search engine results page.

18. The method of claim 15, further comprising, after sending, by the at least one server to the client device, instructions to reorganize the display of the search engine results page within the browser display area of the web browser on the client device, the user-selected Internet resource, and instructions to display the user-selected Internet resource on the client device within the browser display area of the web browser in visual proximity to the reorganized search engine results page while continuing to display the reorganized search engine results page:
receiving, by the at least one server from the client device, instructions for furnishing the client device with a user-selected sub-resource of the Internet resource; and
sending, by the at least one server to the client device, instructions to reorganize the display of at least one of the search engine results page and the Internet resource within the browser display area of the web browser on the client device, the user-selected sub-resource, and instructions to display the user-selected sub-resource on the client device within the web browser the browser display area of the web browser in visual proximity to the search engine results page while and the Internet resource, while continuing to display the search engine results page and the Internet resource.

19. The method of claim 15, further comprising:
receiving, by the at least one server from the client device, instructions for furnishing the client device with an additional Internet resource to which user-selected another one of the ordered series of hyperlinks points; and
sending, by the at least one server to the client device, the additional Internet resource and instructions to display the additional Internet resource within the browser display area of the web browser in place of the Internet resource while continuing to display the reorganized search engine results page.

20. The method of claim 15, further comprising:
receiving, by the at least one server from the client device, instructions for furnishing the client device with an additional Internet resource to which user-selected another one of the ordered series of hyperlinks points; and
sending, by the at least one server to the client device, instructions to reorganize the display of at least one of the search engine results page and the Internet resource within the browser display area of the web browser on the client device, the additional Internet resource, and instructions to display the additional Internet resource on the client device within the browser display area of the web browser in visual proximity to the search engine results page and the Internet resource, while continuing to display the search engine results page and the Internet resource.

21. (canceled)

22. (canceled)

23. (canceled)

24. (canceled)

25. (canceled)

26. (canceled)

27. A system for retrieving information from the Internet, comprising a client device, the client device including:
a computer processor;
a display device operationally connected with the computer processor;
a user interface operationally connected with the computer processor;
a communication interface operationally connected with the computer processor and structured and configured to communicate with at least one server; and
a non-transient computer information storage device operationally connected with the computer processor, the information storage device containing program instructions that, when executed by the computer processor effect:
a sending, by the client device to the at least one server, of a search query to be searched;
a receiving, by the client device from the at least one server, of search results in respect of the search query;
a display of the search results on the client device within a browser display area within a web browser on a search engine results page, the search results including at least an ordered series of hyperlinks pointing to Internet resources;
a receiving, by the client device, of a selection from a user of the client device of one of the ordered series of hyperlinks;
a sending, by the client device to the at least one server, of instructions for furnishing the client device with the Internet resource to which the selected one of the ordered series of hyperlinks points;
a receiving, by the client device from the at least one server, of the selected Internet resource;
a reorganization of the display of the search engine results page within the browser display area of the web browser on the client device; and
a display of the selected Internet resource on the client device within the browser display area of the web browser in visual proximity to the reorganized search engine results page, while continuing to display the reorganized search engine results page.

28. The system of claim 27, wherein the reorganization of the display of the search engine results page within the browser display area of the web browser on the client device includes highlighting the selected one of the ordered series of hyperlinks.

29. The system of claim 27, wherein:
the reorganization of the display of the search engine results page within the browser display area of the web browser on the client device includes a display of the search engine results page within a first column within the browser display area of the web browser on the client device; and
the display of the selected Internet resource on the client device within the browser display area of the web browser in visual proximity to the reorganized search engine results page, while continuing to display the reorganized search engine results page, includes a display of the selected Internet resource on the client device within the browser display area of the web browser in a second column adjacent the first column.

30. The system of claim 27, wherein the program instructions, when executed by the computer processor further effect, after the display of the selected Internet resource on the client device within the browser display area of the web browser in visual proximity to the reorganized search engine results page, while continuing to display the reorganized search engine results page:
a receiving, by the client device, of a selection from the user of the client device of a sub-resource of the selected Internet resource;
a sending, by the client device to the at least one server, of instructions for furnishing the client device with the selected sub-resource;
a receiving, by the client device from the at least one server, of the selected sub-resource; and
a display of the selected sub-resource on the client device within the browser display area of the web browser in place of the selected Internet resource, while continuing to display the reorganized search engine results page.

31. The system of claim 27, wherein the program instructions, when executed by the computer processor further effect, after the display of the selected Internet resource on the client device within the browser display area of the web browser in visual proximity to the reorganized search engine results page, while continuing to display the reorganized search engine results page:
a receiving, by the client device, of a selection from the user of the client device of a sub-resource of the selected Internet resource;
a sending, by the client device to the at least one server, of instructions for furnishing the client device with the selected sub-resource;
a receiving, by the client device from the at least one server, of the selected sub-resource;
a reorganization of the display of at least one of the search engine results page and the selected Internet resource within the browser display area of the web browser on the client device; and
a display of the selected sub-resource on the client device within the browser display area of the web browser in visual proximity to the search engine results pages and the selected Internet resource, while continuing to display the search engine results page and the selected Internet resource.

32. The system of claim 27, wherein the program instructions, when executed by the computer processor further effect:
a receiving, by the client device, of an additional selection from the user of the client device of another one of the ordered series of hyperlinks;
a sending, by the client device to the at least one server, of instructions for furnishing the client device with the Internet resource to which the additional selected one of ordered series of hyperlinks points;
a receiving, by the client device from the at least one server, of the additional selected Internet resource; and
a display of the additional selected Internet resource on the client device within the browser display area of the web browser in place of the Internet resource, while continuing to display the reorganized search engine results page.

33. The system of claim 27, wherein the program instructions, when executed by the computer processor further effect:
a receiving, by the client device, of an additional selection from the user of the client device of another one of the ordered series of hyperlinks;
a sending, by the client device to the at least one server, of instructions for furnishing the client device with the Internet resource to which the additional selected one of ordered series of hyperlinks points;
a receiving, by the client device from the at least one server, of the additional selected Internet resource;
a reorganization of the display of at least one of the search engine results page and the selected Internet resource on the client device; and
a display of the additional selected Internet resource on the client device within the browser display area of the web browser in visual proximity to the search engine results page and the selected Internet resource, while continuing to display the search engine results page and the selected Internet resource.

34. (canceled)

35. (canceled)

36. (canceled)

37. (canceled)

38. (canceled)

39. (canceled)

40. (canceled)

41. A system for supplying information retrieved from the Internet to a client device, comprising at least one server, the at least one server including:
a computer processor;
a database operationally connected with the computer processor, the database containing the information retrieved from the Internet;
a communication interface operationally connected with the computer processor and structured and configured to communicate with the client device; and
a non-transient computer information storage device operationally connected with the computer processor, the information storage device containing program instructions that, when executed by the computer processor effect:
a receiving, by at the least one server from the client device, of a search query to be searched;
an effecting, by the at least one server, of a search in respect of the search query;
a sending, by the at least one server to the client device, of search results in respect of the search query, and of instructions to the client device to display the search results on a search engine results page within a browser display area within a web browser on the client device, the search results including at least an ordered series of hyperlinks pointing to Internet resources;
a receiving, by the at least one server from the client device, of instructions for furnishing the client device with an Internet resource to which a user-selected one of the ordered series of hyperlinks points; and
a sending, by the at least one server to the client device, of instructions to reorganize the display of the search engine results page within the browser display area of the web browser on the client device, of the user-selected Internet resource, and of instructions to display the user-selected Internet resource on the client device within the browser display area of the web browser in visual proximity to the reorganized search engine results page while continuing to display the reorganized search engine results page.

42. The system of claim 41, wherein the sending, by the at least one server to the client device, of instructions to reorganize the display of the search engine results page within the browser display area of the web browser on the client device, of the user-selected Internet resource, and of instructions to display the user-selected Internet resource on the client device within the browser display area of the web browser in visual proximity to the reorganized search engine results page while continuing to display the reorganized search engine results page, includes the sending, by the at least one server to the client device, of instructions to display the search engine results page within a first column within the browser display area of the web browser on the client device, of the user-selected Internet resource, and of instructions to display the user-selected Internet resource within a second column adjacent the first column.

43. The system of claim 41, wherein the program instructions, when executed by the computer processor further effect, after the sending, by the at least one server to the client device, of instructions to reorganize the display of the search engine results page within the browser display area of the web browser on the client device, of the user-selected Internet resource, and of instructions to display the user-selected Internet resource on the client device within the browser display area of the web browser in visual proximity to the reorganized search engine results page while continuing to display the reorganized search engine results page:
a receiving, by the at least one server from the client device, of instructions for furnishing the client device with a user-selected sub-resource of the Internet resource; and
a sending, by the at least one server to the client device, of the user-selected sub-resource of the Internet resource and of instructions to display the user-selected sub-resource on the client device within the browser display area of the web browser in place of the Internet resource while continuing to display the reorganized search engine results page.

44. The system of claim 41, wherein the program instructions, when executed by the computer processor further effect, after the sending, by the at least one server to the client device, of instructions to reorganize the display of the search engine results page within the browser display area of the web browser on the client device, of the user-selected Internet resource, and of instructions to display the user-selected Internet resource on the client device within the browser display area of the web browser in visual proximity to the reorganized search engine results page while continuing to display the reorganized search engine results page:
a receiving, by the at least one server from the client device, of instructions for furnishing the client device with a user-selected sub-resource of the Internet resource; and
a sending, by the at least one server to the client device, of instructions to reorganize the display of at least one of the search engine results page and the Internet resource within the browser display area of the web browser on the client device, of the user-selected sub-resource, and of instructions to display the user-selected sub-resource on the client device within the browser display area of the web browser in visual proximity to the search engine results page while and the Internet resource, while continuing to display the search engine results page and the Internet resource.

45. The system of claim 41, wherein the program instructions, when executed by the computer processor further effect:
a receiving, by the at least one server from the client device, of instructions for furnishing the client device with an additional Internet resource to which user-selected another one of the ordered series of hyperlinks points; and
a sending, by the at least one server to the client device, of the additional Internet resource and of instructions to display the additional Internet resource within the browser display area of the web browser in place of the Internet resource while continuing to display the reorganized search engine results page.

46. The system of 41, wherein the program instructions, when executed by the computer processor further effect:
a receiving, by the at least one server from the client device, of instructions for furnishing the client device with an additional Internet resource to which user-selected another one of the ordered series of hyperlinks points; and
a sending, by the at least one server to the client device, of instructions to reorganize the display of at least one of the search engine results page and the Internet resource within the browser display area of the web browser on the client device, of the additional Internet resource, and of instructions to display the additional Internet resource on the client device within the browser display area of the web browser in visual proximity to the search engine results page and the Internet resource, while continuing to display the search engine results page and the Internet resource.

47. (canceled)

48. (canceled)

49. (canceled)

50. (canceled)

51. (canceled)

52. (canceled)

53. A non-transient computer information storage medium containing program instructions that when executed by a computer processor of a client device effect:
a sending, by the client device to at least one server, of a search query to be searched;
a receiving, by the client device from the at least one server, of search results in respect of the search query;
a display of the search results on the client device within a browser display area within a web browser on a search engine results page, the search results including at least an ordered series of hyperlinks pointing to Internet resources;
a receiving, by the client device, of a selection from a user of the client device of one of the ordered series of hyperlinks;
a sending, by the client device to the at least one server, of instructions for furnishing the client device with the Internet resource to which the selected one of the ordered series of hyperlinks points;
a receiving, by the client device from the at least one server, of the selected Internet resource;
a reorganization of the display of the search engine results page within the browser display area of the web browser on the client device; and
a display of the selected Internet resource on the client device within the browser display area of the web browser in visual proximity to the reorganized search engine results page, while continuing to display the reorganized search engine results page.

54. The non-transient computer information storage medium of claim 53, wherein the reorganization of the display of the search engine results page within the browser display area of the web browser on the client device includes highlighting the selected one of the ordered series of hyperlinks.

55. The non-transient computer information storage medium of claim 53, wherein:
the reorganization of the display of the search engine results page within the browser display area of the web browser on the client device includes a display of the search engine results page within a first column within the browser display area of the web browser on the client device; and
the display of the selected Internet resource on the client device within the browser display area of the web browser in visual proximity to the reorganized search engine results page, while continuing to display the reorganized search engine results page, includes a display of the selected Internet resource on the client device within the browser display area of the web browser in a second column adjacent the first column.

56. The non-transient computer information storage medium of claim 53, wherein the program instructions when executed by the computer processor of the client device further effect, after the display of the selected Internet resource on the client device within the browser display area of the web browser in visual proximity to the reorganized search engine results page, while continuing to display the reorganized search engine results page:
a receiving, by the client device, of a selection from the user of the client device of a sub-resource of the selected Internet resource;
a sending, by the client device to the at least one server, of instructions for furnishing the client device with the selected sub-resource;
a receiving, by the client device from the at least one server, of the selected sub-resource; and
a display of the selected sub-resource on the client device within the browser display area of the web browser in place of the selected Internet resource, while continuing to display the reorganized search engine results page.

57. The non-transient computer information storage medium of claim 53, wherein the program instructions when executed by the computer processor of the client device further effect, after the display of the selected Internet resource on the client device within the browser display area of the web browser in visual proximity to the reorganized search engine results page, while continuing to display the reorganized search engine results page:
a receiving, by the client device, of a selection from the user of the client device of a sub-resource of the selected Internet resource;
a sending, by the client device to the at least one server, of instructions for furnishing the client device with the selected sub-resource;
a receiving, by the client device from the at least one server, of the selected sub-resource;
a reorganization of the display of at least one of the search engine results page and the selected Internet resource within the browser display area of the web browser on the client device; and
a display of the selected sub-resource on the client device within the browser display area of the web browser in visual proximity to the search engine results pages and the selected Internet resource, while continuing to display the search engine results page and the selected Internet resource.

58. The non-transient computer information storage medium of claim 53, wherein the program instructions when executed by the computer processor of the client device further effect:
a receiving, by the client device, of an additional selection from the user of the client device of another one of the ordered series of hyperlinks;
a sending, by the client device to the at least one server, of instructions for furnishing the client device with the Internet resource to which the additional selected one of ordered series of hyperlinks points;
a receiving, by the client device from the at least one server, of the additional selected Internet resource; and
a display of the additional selected Internet resource on the client device within the browser display area of the web browser in place of the Internet resource, while continuing to display the reorganized search engine results page.

59. The non-transient computer information storage medium of claim 53, wherein the program instructions when executed by the computer processor of the client device further effect:
a receiving, by the client device, of an additional selection from the user of the client device of another one of the ordered series of hyperlinks;
a sending, by the client device to the at least one server, of instructions for furnishing the client device with the Internet resource to which the additional selected one of ordered series of hyperlinks points;
a receiving, by the client device from the at least one server, of the additional selected Internet resource;
a reorganization of the display of at least one of the search engine results page and the selected Internet resource on the client device; and
a display of the additional selected Internet resource on the client device within the browser display area of the web browser in visual proximity to the search engine results page and the selected Internet resource, while continuing to display the search engine results page and the selected Internet resource:

60. (canceled)

61. (canceled)

62. (canceled)

63. (canceled)

64. (canceled)

65. (canceled)

66. (canceled)

67. A non-transient computer information storage medium containing program instructions that when executed by a computer processor of at least one server for supplying information retrieved from the Internet to a client device effect:
a receiving, by at the least one server from the client device, of a search query to be searched;
an effecting, by the at least one server, of a search in respect of the search query;
a sending, by the at least one server to the client device, of search results in respect of the search query, and of instructions to the client device to display the search results on a search engine results page within a browser display area within a web browser on the client device, the search results including at least an ordered series of hyperlinks pointing to Internet resources;
a receiving, by the at least one server from the client device, of instructions for furnishing the client device with an Internet resource to which a user-selected one of the ordered series of hyperlinks points; and
a sending, by the at least one server to the client device, of instructions to reorganize the display of the search engine results page within the browser display area of the web browser on the client device, of the user-selected Internet resource, and of instructions to display the user-selected Internet resource on the client device within the browser display area of the web browser in visual proximity to the reorganized search engine results page while continuing to display the reorganized search engine results page.

68. The non-transient computer information storage medium of claim 67, wherein the sending, by the at least one server to the client device, of instructions to reorganize the display of the search engine results page within the browser display area of the web browser on the client device, of the user-selected Internet resource, and of instructions to display the user-selected Internet resource on the client device within the browser display area of the web browser in visual proximity to the reorganized search engine results page while continuing to display the reorganized search engine results page, includes the sending, by the at least one server to the client device, of instructions to display the search engine results page within a first column within the browser display area of the web browser on the client device, of the user-selected Internet resource, and of instructions to display the user-selected Internet resource within a second column adjacent the first column.

69. The non-transient computer information storage medium of claim 67, wherein the program instructions when executed by the computer processor of the at least one server for supplying information retrieved from the Internet to a client device further effect, after the sending, by the at least one server to the client device, of instructions to reorganize the display of the search engine results page within the browser display area of the web browser on the client device, of the user-selected Internet resource, and of instructions to display the user-selected Internet resource on the client device within the browser display area of the web browser in visual proximity to the reorganized search engine results page while continuing to display the reorganized search engine results page:
a receiving, by the at least one server from the client device, of instructions for furnishing the client device with a user-selected sub-resource of the Internet resource; and
a sending, by the at least one server to the client device, of the user-selected sub-resource of the Internet resource and of instructions to display the user-selected sub-resource on the client device within the browser display area of the web browser in place of the Internet resource while continuing to display the reorganized search engine results page.

70. The non-transient computer information storage medium of claim 67, wherein the program instructions when executed by the computer processor of the at least one server for supplying information retrieved from the Internet to a client device further effect, after the sending, by the at least one server to the client device, of instructions to reorganize the display of the search engine results page within the browser display area of the web browser on the client device, of the user-selected Internet resource, and of instructions to display the user-selected Internet resource on the client device within the browser display area of the web browser in visual proximity to the reorganized search engine results page while continuing to display the reorganized search engine results page:
a receiving, by the at least one server from the client device, of instructions for furnishing the client device with a user-selected sub-resource of the Internet resource; and
a sending, by the at least one server to the client device, of instructions to reorganize the display of at least one of the search engine results page and the Internet resource within the browser display area of the web browser on the client device, of the, user-selected sub-resource, and of instructions to display the user-selected sub-resource on the client device within the browser display area of the web browser in visual proximity to the search engine results page while and the Internet resource, while continuing to display the search engine results page and the Internet resource.

71. The non-transient computer information storage medium of claim 67, wherein the program instructions when executed by the computer processor of the at least one server for supplying information retrieved from the Internet to a client device further effect:
a receiving, by the at least one server from the client device, of instructions for furnishing the client device with an additional Internet resource to which user-selected another one of the ordered series of hyperlinks points; and
a sending, by the at least one server to the client device, of the additional Internet resource and of instructions to display the additional Internet resource within the browser display area of the web browser in place of the Internet resource while continuing to display the reorganized search engine results page.

72. The non-transient computer information storage medium of claim 67, wherein the program instructions when executed by the computer processor of the at least one server for supplying information retrieved from the Internet to a client device further effect:
a receiving, by the at least one server from the client device, of instructions for furnishing the client device with an additional Internet resource to which user-selected another one of the ordered series of hyperlinks points; and
a sending, by the at least one server to the client device, of instructions to reorganize the display of at least one of the search engine results page and the Internet resource within the browser display area of the web browser on the client device, of the additional Internet resource, and of instructions to display the additional Internet resource on the client device within the browser display area of the web browser in visual proximity to the search engine results page and the Internet resource, while continuing to display the search engine results page and the Internet resource.

73. (canceled)

74. (canceled)

75. (canceled)

76. (canceled)

77. (canceled)

78. (canceled)
